(19) United States
(12) Patent Application Publication
(10) Pub. No.: US 2025/0234069 A1
(43) Pub. Date: Jul. 17, 2025

(54) TECHNIQUES FOR PERSONALIZED RECOMMENDATION USING HIERARCHICAL MULTI-TASK LEARNING

(71) Applicant: NETFLIX, INC., Los Gatos, CA (US)

(72) Inventors: Moumita BHATTACHARYA, San Jose, CA (US); Yesu FENG, Foster City, CA (US); Sudarshan Dnyaneshwar LAMKHEDE, Sunnyvale, CA (US); Sejoon OH, Santa Clara, CA (US)

(21) Appl. No.: 19/021,012

(22) Filed: Jan. 14, 2025

Related U.S. Application Data
(60) Provisional application No. 63/621,449, filed on Jan. 16, 2024.

(51) Int. Cl. H04N 21/466; G06N 20/00

(52) U.S. Cl. CPC H04N 21/4668; G06N 20/00

(57) ABSTRACT

Techniques for generating recommendations include generating, based on one or more features and a short-term time window, an input feature sequence, generating, based on the input feature sequence, one or more user intent embeddings using a first machine learning model; and generating, based on the input feature sequence and the one or more user intent embeddings, one or more recommendations using a second machine learning model.

### CROSS-REFERENCE TO RELATED APPLICATIONS

This application claims priority benefit of the United States Provisional Patent Application titled, “PREDICTING USER SESSION INTENT WITH HIERARCHICAL MULTI-TASK LEARNING,” filed on Jan. 16, 2024, and having Ser. No. 63/621,449. The subject matter of this related application is hereby incorporated herein by reference.

### BACKGROUND

### Technical Field

The embodiments of the present disclosure relate generally to computer science and machine learning, and more specifically, to techniques for personalized recommendation using hierarchical multi-task learning.

### Description of the Related Art

Recommendation systems are widely used across digital platforms to enhance user experiences by generating personalized content recommendations based on user interactions. Recommendation systems are used in applications, such as video streaming services, e-commerce platforms, and social media, where recommendation systems assist users in discovering relevant content, products, services, and/or the like, aligned with user interests. For example, video streaming platforms, such as Netflix, analyze user engagement data, including watch history and genre preferences, to predict a user's session intent and provide personalized recommendations for movies or TV shows. E-commerce platforms, such as Amazon, eBay, and/or the like, leverage browsing behavior, purchase history, and interaction data to deliver targeted product suggestions, while social media platforms, such as Facebook, Instagram, and/or the like, curate content feeds based on user interactions. One of the prominent uses of machine learning in recommendation systems is in next content item prediction, which aims to predict the user's next engagement based on recent behavior. Accurately predicting the next content item can drive user satisfaction by recommending relevant content at the right moment. Next content item predictions alone cannot capture the underlying user intent in a session, which is often hidden and varies across contexts.

One conventional approach for user intent prediction in recommendation systems includes the use of multi-task learning (MTL) frameworks, where user intent prediction models are added to the next content item prediction models. Multiple related tasks, such as predicting user intent and predicting the next content item of interest, are trained simultaneously using shared representations. The intent prediction models can capture various aspects of user intent based on implicit signals, such as the type of action taken, item categories, user preferences, and/or the like, which are used as additional features in the recommendation process. For example, in an e-commerce platform, a user's recent interactions, such as browsing specific product categories, adding items to a wish list, or frequently revisiting certain types of content, can be used to infer session intents, such as “continue exploring,” “search for new products,” or “compare similar items.” In a social media platform, user interactions, such as liking, sharing, commenting on posts, and/or the like, indicate session user intents, such as “engage with friends' content”, “explore trending topics”, and/or the like In a music streaming service, a user's listening behavior, including skipping tracks, adding songs to a playlist, and/or the like, are used to identify intents, such as “discover new music”, “listen to favorite tracks”, and/or the like.

One drawback of conventional recommendation systems is the lack of a hierarchical prediction structure, where the results of intent prediction do not inform the next content item recommendation. For example, in conventional MTL frameworks, user intent prediction model and next content item prediction model are trained concurrently but treated as separate tasks, which limits the ability of the recommendation system to utilize inferred user intent as an input feature for next content item prediction model. The separation can result in less personalized and less accurate recommendations, as the insights from predicting a user's session intent are not fully leveraged to guide the next content item predictions. For example, in a video streaming service, conventional recommendation systems can predict that a user has the intent to “continue watching” based on user's recent interactions. However, the predicted intent to “continue watching” is not used when recommending new content, leading to recommendations that do not align with the user's intent to resume watching a specific series. In an e-commerce platform, conventional recommendation systems could separately infer that a user is searching for new products, yet the recommended items could only be influenced by past purchases rather than the inferred shopping intent, resulting in product recommendations that do not reflect the user's current exploratory behavior. Similarly, on a music streaming platform, conventional recommendation systems predict the user's intent to “discover new music,” which may not be factored into the next-song recommendations, failing to provide next song recommendations aligned with the user's current discovery intent.

Another drawback of conventional recommendation systems, such as conventional MTL frameworks, is that the conventional recommendation systems do not capture the distinction between short-term and long-term user preferences. Conventional recommendation systems often aggregate user interactions uniformly, without differentiating between immediate session-specific interests and broader habitual preferences. For example, in an e-commerce platform, a user searching for seasonal items, such as holiday decorations and/or the like, could exhibit short-term interests that differ from the usual purchasing patterns, such as buying electronics, clothing, and/or the like. In a music streaming service, a user could temporarily listen to workout playlists while exercising, even if the usual listening habits favor classical or jazz music. In a streaming platform, a user watching children's shows during a family session could have different temporary viewing preferences compared to the usual preferences for action movies or dramas. Failure to account for dynamic shifts in user behavior over short time windows could lead to suboptimal recommendations that do not align with the user's current context.

As the foregoing illustrates, what is needed in the art are more effective techniques for recommendation systems.

### SUMMARY

One embodiment of the present disclosure sets forth a computer-implemented method for generating recommendations. The method includes generating, based on one or more features and a short-term time window, an input feature sequence, generating, based on the input feature sequence, one or more user intent embeddings using a first machine learning model; and generating, based on the input feature sequence and the one or more user intent embeddings, one or more recommendations using a second machine learning model.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to prior art is that the disclosed techniques integrate user intent predictions into the content item prediction process, creating a hierarchical recommendation model. By leveraging inferred user intent embeddings as an input for content item prediction, the disclosed techniques enable more accurate and personalized recommendations aligned with the user's current context. Another advantage of the disclosed techniques is the ability to distinguish between short-term session-specific interests and long-term habitual user preferences, which allows the recommendation model to adapt dynamically to shifts in user behavior over short time windows without losing sight of broader user interaction patterns. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a block diagram of a content server that can be implemented in conjunction with the network infrastructure of FIG. 1, according to various embodiments;

FIG. 3 is a block diagram of a control server that can be implemented in conjunction with the network infrastructure of FIG. 1, according to various embodiments;

FIG. 4 is a block diagram of an endpoint device that can be implemented in conjunction with the network infrastructure of FIG. 1, according to various embodiments;

FIG. 5 is a block diagram of a computer-based system according to various embodiments;

FIG. 6 is a more detailed illustration of the input processing module of FIG. 5, according to various embodiments;

FIG. 7 is a more detailed illustration of the model trainer of FIG. 5, according to various embodiments;

FIG. 8 is a more detailed illustration of the recommendation application of FIG. 5, according to various embodiments;

FIG. 9 is a more detailed illustration of an example of recommendation model of FIG. 5, according to various embodiments;

FIG. 10 sets forth a flow diagram of method steps for training the recommendation model of FIG. 5, according to various embodiments;

FIG. 11 sets forth a flow diagram of method steps for generating an input feature sequence, according to various embodiments; and

FIG. 12 sets forth a flow diagram of method steps for generating recommendations, according to various embodiments.

### DETAILED DESCRIPTION

In the following description, numerous specific details are set forth to provide a more thorough understanding of the embodiments of the present invention. However, it will be apparent to one skilled in the art that the embodiments of the present invention may be practiced without one or more of these specific details.

### System Overview

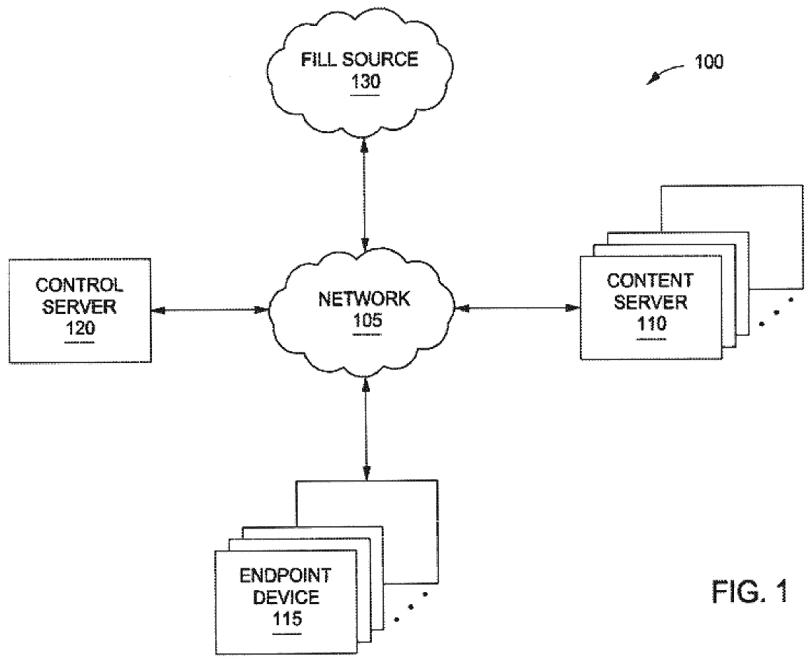

FIG. 1 illustrates a network infrastructure 100 used to distribute content to content servers 110 and endpoint devices 115, according to various embodiments of the invention. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, database, and server application 217 configured to communicate with the control server 120 to determine the location and availability of various files that are tracked and managed by the control server 120. Each content server 110 may further communicate with a fill source 130 and one or more other content servers 110 in order “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

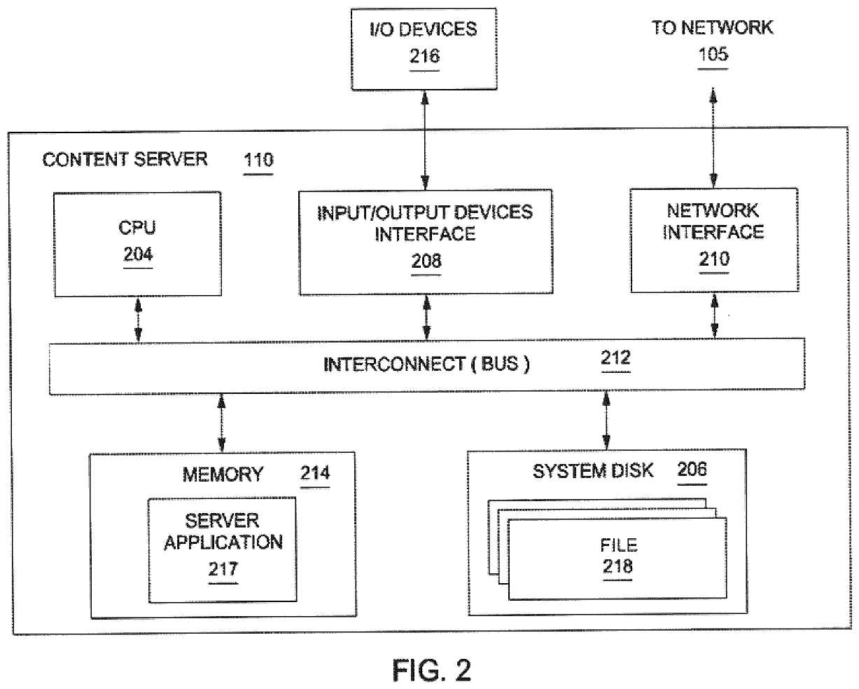

FIG. 2 is a block diagram of a content server 110 that may be implemented in conjunction with the network infrastructure 100 of FIG. 1, according to various embodiments of the present invention. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

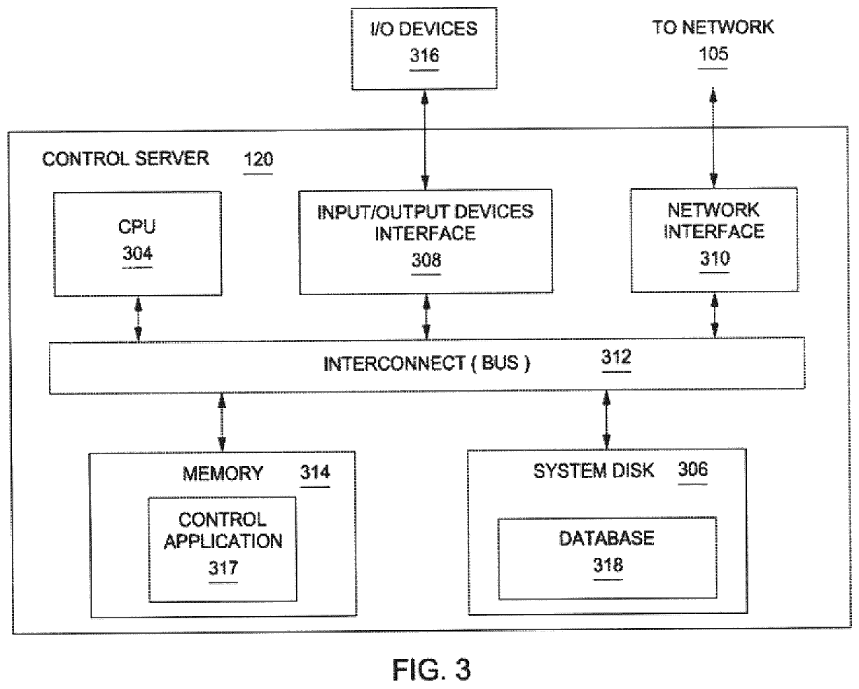

FIG. 3 is a block diagram of a control server 120 that may be implemented in conjunction with the network infrastructure 100 of FIG. 1, according to various embodiments of the present invention. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 206 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

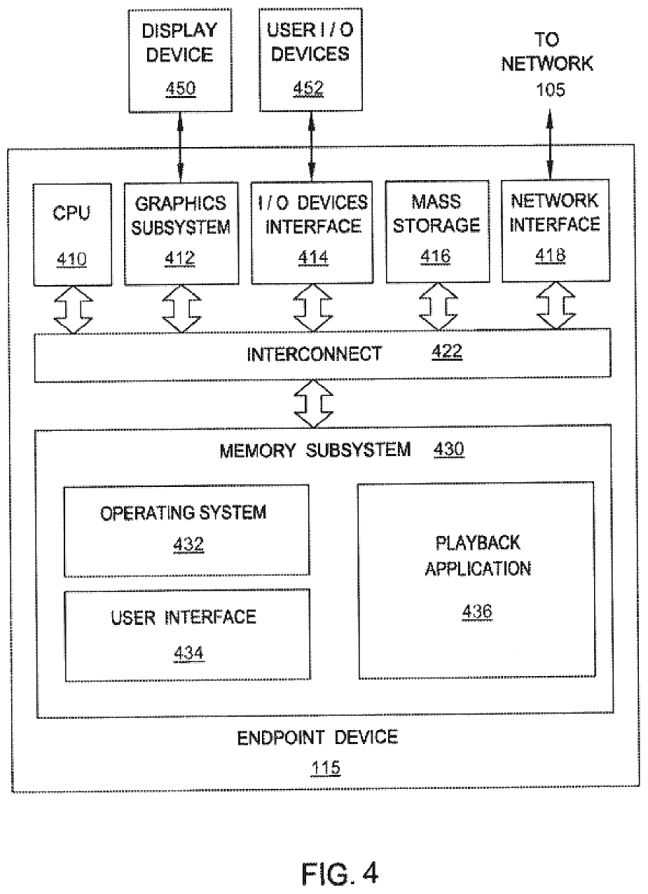

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage unit 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage unit 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage unit 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage unit 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 108. Persons skilled in the art will recognize the various operating systems and user interfaces that are well-known in the art and suitable for incorporation into the endpoint device 108.

In some embodiments, the playback application 436 is configured to request and receive content from the content server 110 via the network interface 418. Further, the playback application 436 is configured to interpret the content and present the content via display device 450 and/or user I/O devices 452.

### Personalized Recommendation Using Hierarchical MTL

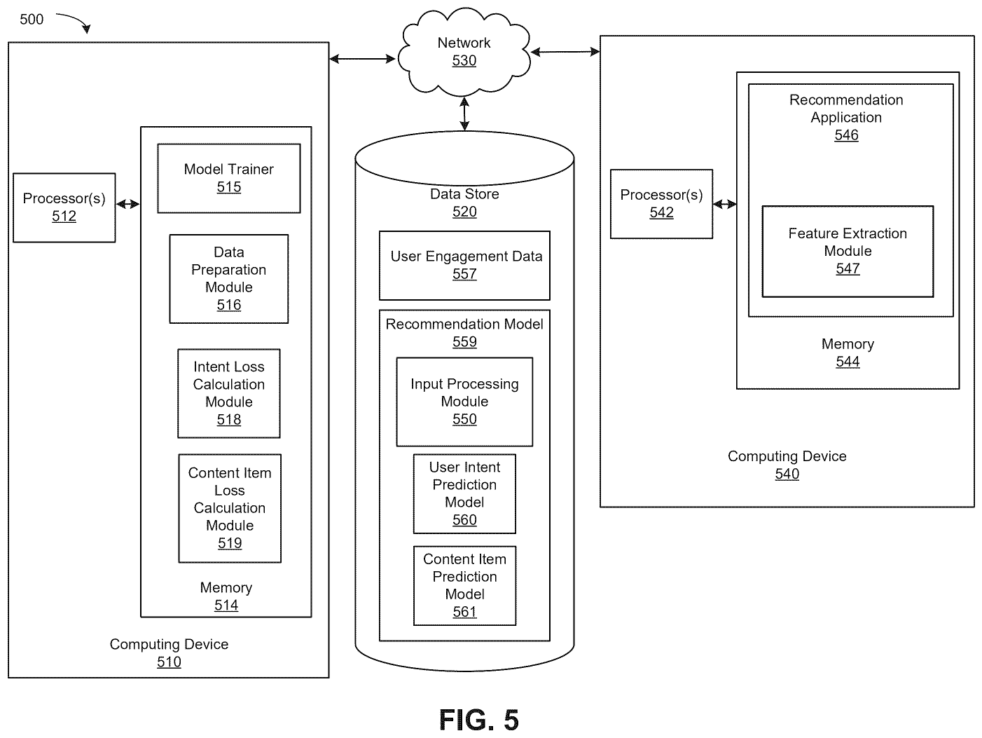

FIG. 5 is a block diagram of a computer-based system 500 according to various embodiments. As shown, the computer-based system 500 includes, without limitation, computing devices 510 and 540, a data store 520, and a network 530. Computing device 510 includes, without limitation, one or more processors 512 and memory 514. Memory 514 includes, without limitation, a model trainer 515, a data preparation module 516, an intent loss calculation module 518, and a content item loss calculation module 519. Data store 520 includes, without limitation, user engagement data 557 and a recommendation model 559. Recommendation model 559 includes, without limitation, an input processing module 550, a user intent prediction model 560, and a content item prediction model 561. Computing device 540 includes, without limitation, one or more processors 542 and memory 544. Memory 544 includes, without limitation, a recommendation application 546. Recommendation application 546 includes, without limitation, a feature extraction module 547. Although FIG. 5 is described in the context of recommendation systems, it is understood that the disclosed techniques are also applicable to other areas of personalization and data-driven systems, such as targeted advertising platforms, product recommendation engines, dynamic user interface customization, personalized educational content delivery, and/or the like.

Computing device 510 shown herein is for illustrative purposes only, and variations and modifications in the design and arrangement of computing device 510, without departing from the scope of the present disclosure. For example, the number of processors 512, the number of and/or type of memories 514, and/or the number of applications and or data stored in memory 514 can be modified as desired. In some embodiments, any combination of processor(s) 512 and/or memory 514 can be included in and/or replaced with any type of virtual computing system, distributed computing system, and/or cloud computing environment, such as a public, private, or a hybrid cloud system.

Each of processor(s) 512 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 512 can be any technically feasible hardware unit capable of processing data and/or executing software applications.

Memory 514 of computing device 510 stores content, such as software applications and data, for use by processor(s) 512. As shown, memory 514 includes, without limitation, a model trainer 515, a data preparation module 516, an intent loss calculation module 518, and a content item loss calculation module 519. Memory 514 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 514. The storage can include any number and type of external memories that are accessible to processor(s) 512. For example, and without limitation, the storage can include a Secure Digital Card, an external Flash memory, a portable CD-ROM, an optical storage device, a magnetic storage device, and/or any suitable combination of the foregoing.

User engagement data 557 includes broad patterns of user behavior and activity across various recommendation tasks, providing insights into what the users engage with, how the users interact, the preferences of the users over time, and/or the like. In various embodiments, user engagement data 557 is split into training data, validation data, and test data across various content items. For example, user engagement data 557 can include samples from approximately 2.2 million training users, 181,000 validation users, and 176,000 test users, with a total of 35,000 distinct content items. In some embodiments, user engagement data 557 includes rich metadata, including but not limited to action type, genre, movie or show label, timestamps, and duration of engagement. In some embodiments, user engagement data 557 includes at least four features: action type, genre preference, movie or show type, and time-since-release. In some examples, the action type metadata includes 11 distinct categories of user behavior, such as discovering new content, binge-watching, and re-watching, generated using a rule-based algorithm that focuses on core user activities indicative of session-level intent. Genre metadata includes 21 predefined labels (e.g., comedy, thriller, action), which provide insights into users' content preferences and help capture users' implicit genre interests. The movie or show label includes a binary feature indicating whether the content item is a movie or a TV show, reflecting the user's initial choice and indicating different viewing user intents based on expected content duration. Additionally, time-since-release metadata includes at least three labels representing the recency of the content item (e.g., released within a week, within a month, or older), which helps identify users' preferences for new versus older content items. In various embodiments, model trainer 515 uses user engagement data 557 in mini batches. The mini batches are processed by data preparation module 516 which generates one or more features. Input processing module 550 processes the one or more features and generates an input feature sequence based on a preset short-term time window.

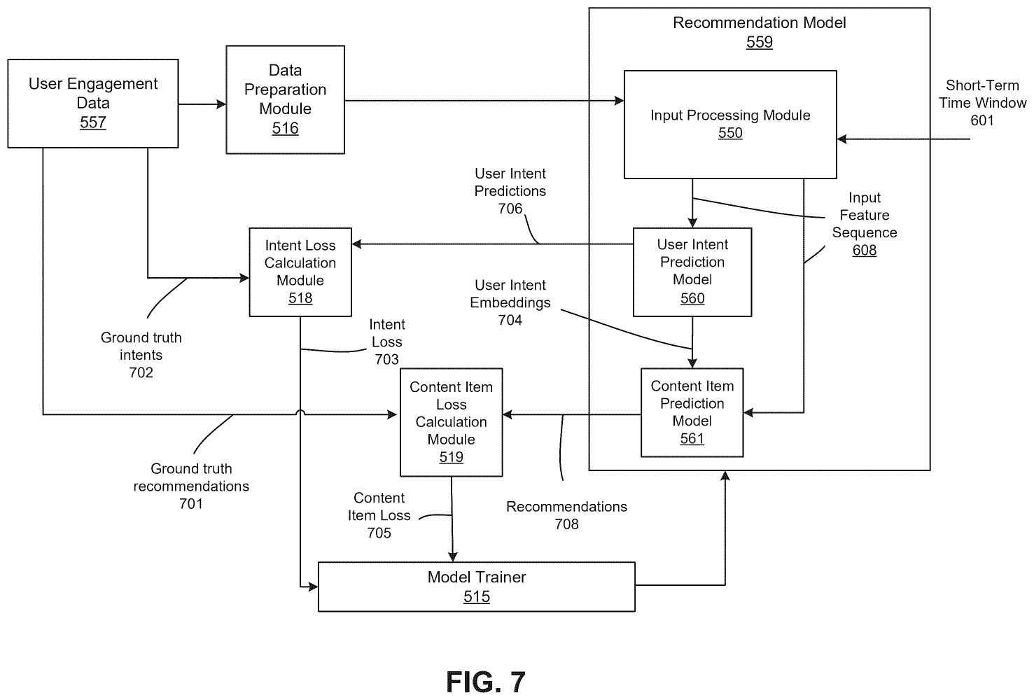

Model trainer 515 trains recommendation model 559 using user engagement data 557. In some embodiments, model trainer 515 uses the input feature sequence to optimizes the parameters of user intent prediction model 560 and content item prediction model 561 jointly using a hierarchical approach. During training, the intent predictions are made first, generating auxiliary signals that are then fed as input embeddings (e.g., user intent embeddings) into the content item prediction model 561. Model trainer 515 uses intent loss calculation module 518 to evaluates the accuracy of the user intent predictions (e.g., user intent embeddings) by comparing user intent predictions against ground truth labels included in user engagement data 557 generating an intent loss. In some examples, ground truth labels include multiple intent labels (e.g., a user session including both “romance” and “comedy” intents). Model trainer 515 also uses content item loss calculation module 519 to evaluate the accuracy of the recommendations (e.g., content item predictions) by comparing the recommendations with the ground truth recommendations included in user engagement data 557 generating a content item loss. In various embodiments, model trainer 515 aggregates the intent loss and the content item loss. In various embodiments, model trainer 515 prioritizes user interactions based on duration, assigning greater weight to longer interactions, as longer interactions are considered more informative and valuable for capturing user preferences. In some embodiments, model trainer 515 trains recommendation model 559 in iterative training cycles, employing cross-validation, early stopping, and/or the like, to avoiding overfitting. In at least one embodiment, model trainer 515 uses various standard ranking metrics for evaluation of recommendations, such as mean reciprocal rank (MRR) and weighted MRR (WMRR). For example, model trainer 515 uses MRR and WMRR to evaluate how accurately recommendation model 559 predicts the next content item. Model trainer 515 is described in more detail in conjunction with FIG. 7.

Data preparation module 516 processes user engagement data 557 and generates one or more features. In various embodiments, data preparation module 516 performs data cleaning, feature extraction, and transformation of raw user interaction data into structured formats suitable for training recommendation model 559. The data preparation process includes extracting both numerical features and categorical features from user engagement data 557. Numerical features include metadata, such as timestamps, content duration, and interaction counts, which are normalized to ensure consistent scaling across different data points. Categorical features include information, such as action type (e.g., discovering new content, binge-watching), genre preference (e.g., comedy, thriller), content type (e.g., movie or TV show), time-since-release labels (e.g., newly released vs. older content), and/or the like. In some embodiments, data preparation module 516 segments user engagement data 557 into short-term and long-term sequences, enabling recommendation model 559 to differentiate between immediate session-specific interests and broader habitual preferences.

Data store 520 can include any storage device or devices, such as fixed disc drive(s), flash drive(s), optical storage, network attached storage (NAS), and/or a storage area-network (SAN). Although shown as accessible over network 530, in some embodiments computing device 510 can include data store 520. As shown, data store 520 is storing, without limitation, user engagement data 557 and recommendation model 559. Although shown as stored in datastore 520, in some embodiments, recommendation model 559 and user engagement data 557 can be stored in separate data stores. For example, recommendation model 559 could be stored in a cloud-based model repository, such as Amazon S3, Azure Blob Storage, and/or the like, to facilitate model versioning and scalability, while user engagement data 557 could be stored in a high-performance distributed database, such as Apache Cassandra, Google Bigtable, and/or the like, optimized for handling large-scale user interaction data.

Recommendation model 559 is a machine learning model, which includes input processing module 550, user intent prediction model 560, and content item prediction model 561, and processes one or more features generating recommendations. For example, in a video streaming platform, recommendations include next content item predictions, suggesting the next movie, TV show, or episode the user is likely to watch. In an e-commerce platform, recommendations include a ranked list of products tailored to the user's recent browsing history and preferences, such as recommending related items or suggesting new categories to explore. In a music streaming service, recommendations include the next song or playlist, aligning with the user's current listening behavior and mood. In some embodiments, recommendations are accompanied by a score (e.g., a rank) that indicates the predicted likelihood of user engagement with a content item.

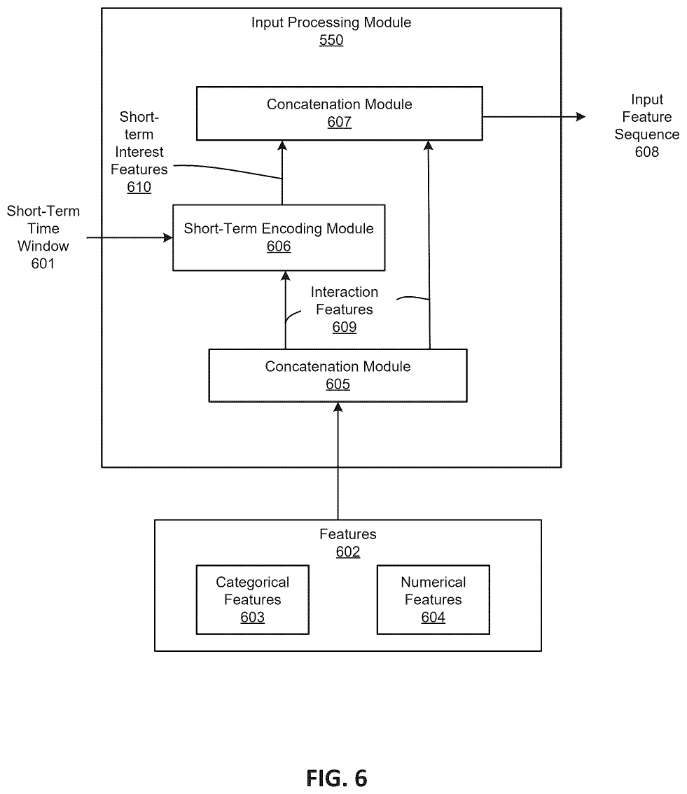

Input processing module 550 processes one or more features and generates an input feature sequence. In various embodiments, input processing module 550 concatenates numerical features and categorical features included in the one or more features generating interaction features. Input processing module 550 then uses a short-term time window to process interaction features and generate short-term interest features. In various embodiments, instead of using a fixed number of recent user interactions, input processing module 550 considers user interactions that occur within the short-term time window (e.g., one week, one day), which dynamically adapts to different user behaviors. Input processing module 550 concatenates short-term interest features with interaction features generating the input feature sequence. Input processing module 550 is described in more detail in conjunction with FIG. 6.

User intent prediction model 560 is a machine learning model, such as a neural network, which processes the input feature sequence, generates user intent embeddings and optionally generates user intent predictions. User intent prediction model uses input feature sequence to infer the current intent of users, such as whether a user is continuing a previously started activity, searching for new content, looking for specific types of content items based on recent interactions, and/or the like. In some embodiments, user intent prediction model 560 uses the order and timing of user interactions, using timestamp information to preserve the sequence context. In at least one embodiment, user intent prediction model 560 examines patterns in the behavior of users to predict various aspects of user intent, including content preferences (e.g., genre), session objectives (e.g., discovering new items or revisiting familiar ones), and the type of content the user prefers (e.g., movies versus TV shows). User intent predictions are then combined into a single representation that summarizes the user's intent for the current session. User intent predictions help provide personalized experiences, as user intent predictions enable recommendation systems to align recommendations, user interfaces, and content prioritization with the user's current intents. User intent predictions have broad applicability in downstream recommendations tasks, such as improving recommendation accuracy, refining search results, enhancing user engagement, and/or the like. In some embodiments, user intent prediction model 560 weighs each intent prediction according to the importance of intent prediction based on the user's recent activities and context, resulting in the user intent embedding that reflects various aspects of the user's behavior and preferences at that moment. In various embodiments, user intent prediction model 560 uses proxy signals, such as the type of user action (e.g., continuing a series or exploring new genres), to infer latent user intents, such as “continue watching”, “discover new content”, and/or the like and generate user intent embeddings. In some examples, user intent prediction model 560 includes a fully connected layer, an intent encoding transformer, fully connected and normalization layers, and attention layers.

Content item prediction model 561 is a machine learning model, such as a neural network, which processes user intent embeddings and input feature sequence and generates recommendations. In various embodiments, content item prediction model 561 concatenates input feature sequence with the user intent embeddings. Content item prediction model 561 then analyzes the concatenated input, taking into account the sequence of user interactions and the timing of the interactions, where content item prediction model 561 uses sequential information to identify patterns and trends in user behavior, predicting the next content item the user is likely to engage with. By recognizing shifts in user preferences and considering session-level intent, content item prediction model 561 can dynamically update recommendations, providing personalized content recommendations that align with both short-term interests and long-term habits of a user. In various embodiments, content item prediction model 561 generates recommendations that include a ranked list of content items, each assigned a score that indicates the predicted likelihood of user engagement. In some embodiments, content item prediction model 561 recommends the content with the highest scores to the user. In some examples, content item prediction model 561 includes a concatenation layer, fully connected and normalization layers, an item encoding transformer, and fully connected layers.

Network 530 can be a wide area network (WAN), such as the Internet, a local area network (LAN), a cellular network, and/or any other suitable network. Computing devices 510 and 540 and data store 520 are in communication over network 530. For example, network 530 can include any technically feasible network hardware suitable for allowing two or more computing devices to communicate with each other and/or to access distributed or remote data storage devices, such as data store 520.

Computing device 540 shown herein is for illustrative purposes only, and variations and modifications in the design and arrangement of computing device 540, without departing from the scope of the present disclosure. For example, the number of processors 542, the number of and/or type of memories 544, and/or the number of applications and or data stored in memory 544 can be modified as desired. In some embodiments, any combination of processor(s) 542 and/or memory 544 can be included in and/or replaced with any type of virtual computing system, distributed computing system, and/or cloud computing environment, such as a public, private, or a hybrid cloud system.

Each of processor(s) 542 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 542 can be any technically feasible hardware unit capable of processing data and/or executing software applications. During operation, processor(s) 542 can receive user inputs and context inputs from input devices (not shown), such as a keyboard or a mouse.

Memory 544 of computing device 540 stores content, such as software applications and data, for use by processor(s) 542. As shown, memory 544 includes, without limitation, a recommendation application 546. Memory 544 can be any type of memory capable of storing data and software applications, such as RAM, ROM, EPROM or Flash ROM, or any suitable combination of the foregoing. In some embodiments, additional storage (not shown) can supplement or replace memory 544. The storage can include any number and type of external memories that are accessible to processor(s) 542. For example, and without limitation, the storage can include a Secure Digital Card, an external Flash memory, a portable CD-ROM, an optical storage device, a magnetic storage device, and/or any suitable combination of the foregoing.

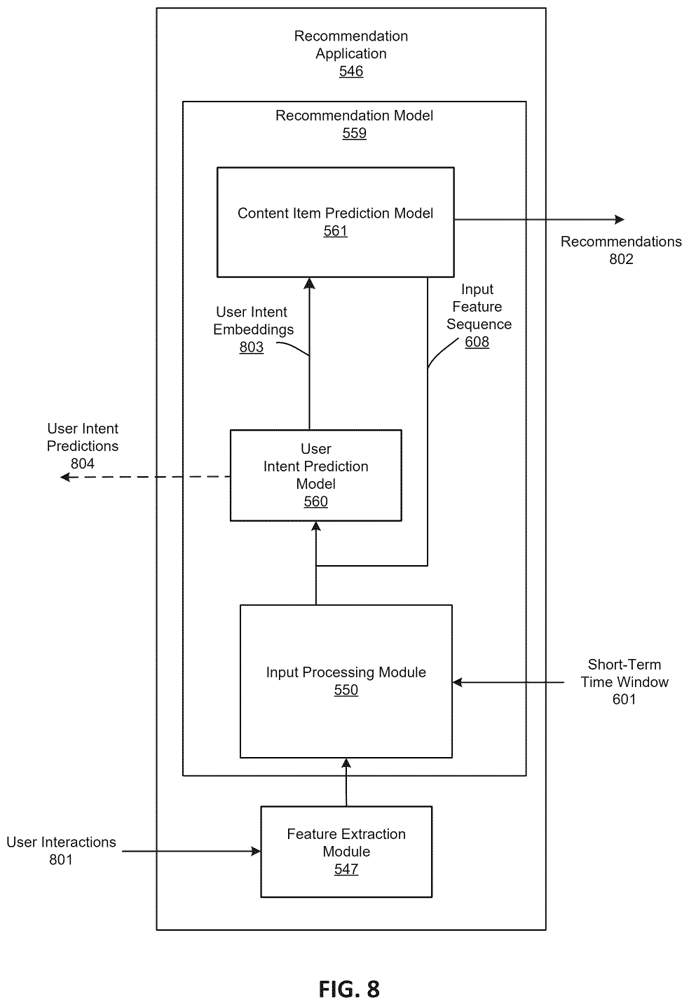

Recommendation application 546 processes user interactions, generates recommendations, and optionally generates user intent predictions. In various embodiments, recommendation application 546 receives user interactions through various I/O devices (not shown), including direct interactions, browsing activity, and implicit feedback, such as engagement duration, skipped items, and/or the like. As shown, recommendation application 546 includes, without limitation, a feature extraction module 547. Feature extraction module 547 processes user interactions and generates one or more features. The one or more features include numerical features, such as timestamps, session duration, and/or the like, and categorical features, such as item type, action type, user preferences, and/or the like. In various embodiments, recommendation application 546 uses the trained recommendation model 559 and the short-term time window to process one or more features, generate recommendations, and optionally generate user intent predictions. Recommendation application 546 is described in more detail in conjunction with FIG. 8.

FIG. 6 is a more detailed illustration of the input processing module, according to various embodiments. As shown, input processing module 550 includes, without limitation, a concatenation module 605, a short-term encoding module 606, and a concatenation module 607.

Concatenation module 605 concatenates categorical features 603 and numerical features 604 included in one or more features 602 generating interaction features 609. Interaction features 609 [symbol] , k=1, . . . , n, include a concatenation of categorical features 603, such as item-ID (iₖ), action type (cₖ), genre (gₖ), and/or the like, with numerical features 604, such as timestamp (tₖ), episode position (eₖ), and/or the like. In various embodiments, concatenation module 605 converts categorical features of an interaction (intₖ) into embeddings using trainable embedding layers, where each categorical feature 603 is mapped to a specific embedding vector. In some examples, item-ID embeddings have the largest dimension (e.g., 400), while other categorical features 603, such as action type and genre use smaller dimensions (e.g., 20). In at least one embodiment, concatenation module 605 normalizes numerical features 604 (e.g., scaled between 0 and 1) and treats numerical features 604 as 1-dimensional features. Interaction feature 609 for an interaction k, denoted as [symbol] , is formed by concatenating the embeddings of the categorical features 603 with the normalized numerical features 604, represented as:

$${ℱ}_{k} = E ( {i}_{k} ) ⊕ E ( {c}_{k} ) ⊕ E ( {g}_{k} ) ⊕ {t}_{k} ⊕ {e}_{k} \qquad ( Equation 1 )$$

where ß denotes the concatenation operator, and E(·) represents the trainable embedding layer for each categorical feature 603.

Short-term encoding module 606 uses a short-term time window 601 to process interaction features 609 and generate short-term interest features 610. Short-term time window 601 is defined by a hyperparameter H, which represents a fixed duration, such as 1 week, 1 day, 1 hour, and/or the like, depending on the specific application and user behavior patterns. In various embodiments short-term encoding module 606 identifies recent user interactions within H and aggregates the corresponding interaction features 609. In some embodiments, short-term encoding module 606 uses a personalized timestamp-based approach, extracting the most relevant signals from the user's recent interactions and capturing session-specific interests to generate short-term interest features 610 Sₖ. In some examples, short-term encoding module 606 uses an encoder Enc(·) to generate short-term interest features 610 Sₖ as described below

$${𝒮}_{k} ∈ {ℝ}^{{d}_{short}} = E nc ( {ℱ}_{pos} , … , {ℱ}_{k} ) = {arg min}_{1 \leq i \leq k} ( {𝒯}_{k} - {𝒯}_{i} \leq H ) , \qquad ( Equation 2 )$$

where [symbol] is the timestamp of user interaction i.

Concatenation module 607 concatenates short-term interest features 610 and interaction features 609 and generates input feature sequence 608. In various embodiments concatenation module 607 concatenates short-term interest features 610 { [symbol] , . . . , [symbol] } with the interaction features 609 { [symbol] , . . . , [symbol] } to generate input feature sequence 608 { [symbol] ß [symbol] , . . . , [symbol] ß [symbol] }.

FIG. 7 is a more detailed illustration of the model trainer 515, according to various embodiments. As shown, model trainer 515 uses user engagement data 557 and short-term time window 601 to train recommendation model 559. As shown, user engagement data 557 includes, without limitation, ground truth recommendations 701 and ground truth intents 702. Model trainer 515, receives, without limitation, intent loss 703 from intent loss calculation module 518 and content item loss 705 from content item loss calculation module 519 to train recommendation model 559.

In operation, model trainer 515 prepares user engagement data 557 by splitting user engagement data 557 into training and test datasets, ensuring that the test dataset remains separate from the training dataset to maintain unbiased evaluation. User engagement data 557 of a user u includes historical interactions (e.g., clicks and plays) the user has made. In some examples, model trainer 515 uses the latest n (e.g., 100) user interactions of each user for training and testing. Each user u's engagement is represented as a temporal user interaction sequence int₁, . . . , intₙ with intₙ being the most recent user interaction. In some embodiments, model trainer 515 divides user engagement data 557 into mini batches B. Data preparation module 516 processes user engagement data 557 and generates one or more features 602. Input processing module 550 processes one or more features 602 based on short-term time window 601 and generates input feature sequence 608.

User intent prediction model 560 processes input feature sequence 608, generates user intent embeddings 704 Zₖ, and generates user intent predictions 706. User intent embeddings 704 represent the user's current intent for each user interaction within input feature sequence 608. In various embodiments, user intent prediction model 560 identifies patterns in the user interactions by analyzing both short-term session-level features and long-term behavioral trends included input feature sequence 608. Each user intent embedding 704 aggregates predictions across various intent categories, such as action type (e.g., “explore new content,” “continue watching”), content genre preferences (e.g., “drama,” “comedy”), and content type (e.g., “movie,” “TV show”). For example, if a user's recent interactions indicate frequent rewatching of specific shows, user intent prediction model 560 could assign higher probabilities to the “continue watching” intent, reflecting the user's preference to resume previously watched content. In some embodiments, user intent embeddings 704 are generated by analyzing temporal dependencies, based on the timestamp and ordering information to model how user behavior evolves over time. In some examples, user intent prediction model 560 includes an intent encoding transformer that models long-term user interests using multi-head attention mechanisms and timestamp-based positional encoding to maintain temporal dependencies. User intent prediction model 560 also includes a causal mask ensures that user intent prediction model 560 only attends to past user interactions, preventing future bias. The intent encoding transformer generates an intent encoding sequence, which is further used to predict multiple intent categories, such as action type, genre preferences, and/or the like. Each user intent prediction 706 can represent a probability distribution over possible intent labels. The individual user intent predictions 706 are then aggregated into user intent embeddings 704 using projection layers and an attention mechanism, which assigns importance weights to each intent prediction.

Content item prediction model 561 processes input features sequence 608 and user intent embeddings 704 and generates recommendations 708. Recommendations 708 includes a ranked list of content items, each assigned a score indicating the likelihood of user engagement. For example, in an e-commerce platform, recommendations 708 could include a list of products tailored to the user's shopping history and current browsing behavior, while in a video streaming service, recommendations 708 could include movies or TV shows that align with the user's genre preferences and recent viewing patterns. In some examples, content item prediction model 561 concatenates input feature sequence 608 with user intent embeddings 704 generating an intent-aware feature sequence. Content item prediction model 561 includes an item encoding transformer which processes the intent-aware feature sequence. The item encoding transformer generates optimized representations for each position in the intent-aware sequence, which are then transformed into prediction scores for each content item.

Content item loss calculation module 519 processes recommendations 708 and generates content item loss 705 based on ground truth recommendations 701 included in user engagement data 557. In some embodiments, for each position k in a user profile, content item prediction model 561 predicts the next content item iₖ₊₁. Content item loss calculation module 519 uses different weights proportional to the duration of various content items. The weighting emphasizes user interactions with longer durations, as user interactions with longer durations could have higher importance or business value. For instance, if a user watches an entire movie compared to briefly browsing through a list of titles, the movie-watching interaction could receive a higher weight. In some examples, given the current mini-batch B, content item loss calculation module 519 uses the following weighted-Cross-Entropy loss for next content item prediction:

$${ℒ}_{item} = - {\sum }_{u ∈ ℬ} {\sum }_{k = 1}^{n} {d}_{k} {\sum }_{i = 1}^{\vert I \vert} {y}_{k}^{I} [ i ] \cdot log ( {p}_{k}^{item} [ i ] ) \qquad ( Equation 3 )$$

where dₖ is the duration weight of the k-th user interaction, yₖ is a one-hot vector indicating the ground-truth next item iₖ₊₁, pₖ^{item} is the probability (e.g., score) of content item k, x[i] means the i-th element of a vector x, and where |I| is the total number of content items in a recommendation catalog.

Intent loss calculation module 518 processes user intent predictions 706 and generates intent loss 703 based on ground truth intents 702. In some examples, intent loss 703 Lᵢₙₜₑₙₜ_{ᵢ} is defined similar to [symbol] as described in Equation 3. In some embodiments, if the user intent prediction 706 has multiple ground-truth labels (e.g., an intent= “romance”+ “comedy”), intent loss calculation module 518 uses Binary Cross-Entropy, where all the ground-truth labels become positive labels and no ground truths have negative labels. For example, if a user exhibits intent to watch both comedy and romance content items, intent loss calculation module 518 ensures that both labels are correctly predicted, assigning equal importance to each of the two content items.

Model trainer 515 uses content item loss 705 and intent loss 703 to calculate a total loss. In some examples, the total loss is calculated as:

$${ℒ}_{tota1} = {ℒ}_{I t e m} + λ {\sum }_{i = 1}^{M} {ℒ}_{i n t e n {t}_{i}} \qquad ( Equation 4 )$$

where λ is an intent prediction coefficient which balances the influence of intent prediction and content item prediction. For example, strong emphasis on intent prediction (e.g., λ=1.0) leads to both high content item and intent prediction accuracy. In some embodiments, intent prediction coefficient is a trainable parameter. In some embodiments, model trainer 515 updates the parameters of recommendation model 559 based on total loss using an optimization algorithm, such as adaptive moment estimation (Adam). In at least one embodiment, model trainer 515 trains recommendation model 559 iteratively until a stopping criterion is met, such as reaching a maximum number of iterations, a plateauing loss function, and/or the like. In various embodiments, model trainer 515 uses various standard ranking metrics typically used in recommendation systems for evaluation. In some examples, model trainer 515 uses MRR and WMRR metrics, which indicate how accurately recommendation model 559 predicts the next content item iₙ₊₁ of a test user u belonging to the test dataset “Test” given her n observed content items {i₁, . . . , iₙ}. MRR and WMRR metrics are defined as follows

$$MRR = \frac{1}{( \vert Test \vert ) {\sum }_{U ∈ T e s t}} \frac{1}{R ( {i}_{n + 1} )} and \qquad ( Equation 5 )$$

$$WMRR = \frac{{\sum }_{u ∈ Test} \frac{{d}_{n + 1}}{R ( {i}_{n + 1} )}}{{\sum }_{u ∈ Test} {d}_{n + 1}} \qquad ( Equation 6 )$$

where dᵢ is duration of a user interaction (e.g., playtime), and R (i) is a predicted rank of a content item i among all content items. Once the training of recommendation model 559 is complete, model trainer 515 stores recommendation model 559 in data store 520, or elsewhere.

FIG. 8 is a more detailed illustration of the recommendation application 546 of FIG. 5, according to various embodiments. As shown, recommendation application 546 includes, without limitation, feature extraction module 547 and uses the trained recommendation model 559 and short-term time window 601 to process user interactions 801 and generate recommendations 802. The trained recommendation model 559 includes, without limitation, input processing module 550, the trained user intent prediction model 560, and the trained content item prediction model 561. The trained recommendation model 559 processes one or more features generated based on user interactions 801, generates recommendations 802, and optionally generates user intent predictions 804 using short-term time window 601.

Recommendation application 546 processes user interactions 801, generates recommendations 802, and optionally generates user intent predictions 804. In various embodiments, recommendation application 546 receives user interactions 801 through various I/O devices (not shown), including direct interactions, browsing activity, and implicit feedback, such as engagement duration, skipped items, and/or the like. In various embodiments, recommendation application 546 uses the trained recommendation model 559 and the short-term time window to process one or more features, generate recommendations 802, and optionally generate user intent predictions 804.

Feature extraction module 547 processes user interactions 801 and generates one or more features. In various embodiments, feature extraction module 547 maps each user interaction 801 intₖ, 1≤k≤n, to various metadata attributes and extracts one or more features, which include categorical features 603 and numerical features 604.

Input processing module 550 included in the trained recommendation model 559 uses short-term time window 601 to process one or more features and generate input feature sequence 608 { [symbol] ß [symbol] , . . . , [symbol] ß [symbol] }.

The trained user intent prediction model 560 processes input feature sequence 608, generates user intent embeddings 803, and optionally generates user intent predictions 804. User intent embeddings 803 represent various aspects of user intent, including but not limited to predicted scores or probabilities for various intent categories, such as action type (e.g., “discover new content” or “binge-watch”), genre preference (e.g., “thriller” or “romance”), and content type preference (e.g., “TV show” or “movie”). For example, if the user has recently interacted with multiple thriller movies in quick succession, user intent embeddings 803 could indicate a high probability of the user being interested in similar suspenseful or high-intensity content. Additionally, user intent predictions 804 provide insights into specific user behaviors by generating probability distributions over various intent labels, allowing the recommendation system to identify the most likely intent categories for a given session. For example, if a user alternates between exploring new genres and continuing previously watched content, user intent predictions 804 can highlight the dominant intent, such as “continue watching,” and adjust downstream recommendations accordingly.

The trained content item prediction model 561 processes user intent embeddings 803 and input feature sequence 608 and generates recommendations 802. Recommendations 802 can include a ranked list of content items, each assigned a score or probability indicating the predicted likelihood of user engagement. For example, on a video streaming platform, recommendations 802 could include a list of movies or TV shows tailored to the user's inferred preferences, such as recommending more thriller movies after detecting an interest in that genre. In an e-commerce platform, recommendations 802 could include products related to a recently browsed category (e.g., “fitness gear” or “home appliances”).

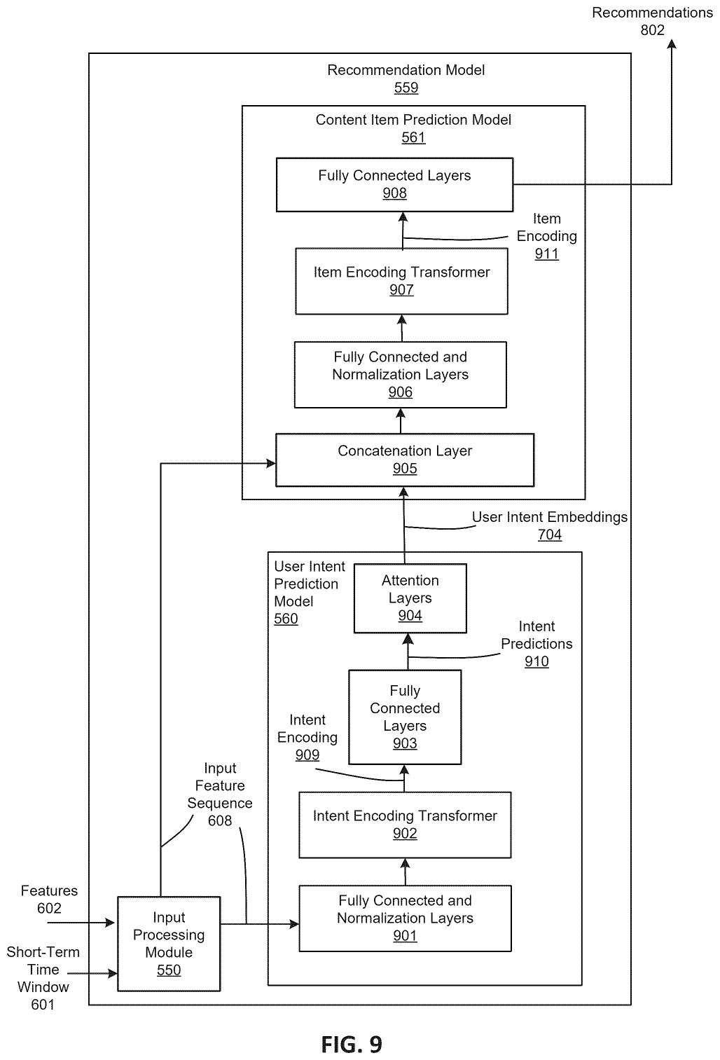

FIG. 9 is a more detailed illustration of an example of recommendation model 559, according to various embodiments. As shown, recommendation model 559 includes, without limitation, input processing module 550, user intent prediction model 560, and content item prediction model 561. User intent prediction model 560 includes, without limitation, one or more fully connected and normalization layers 901, an intent encoding transformer 902, one or more fully connected layers 903, and one or more attention layers 904. Content item prediction model 561 includes, without limitation, a concatenation layer 905, one or more fully connected and normalization layers 906, an item encoding transformer 907, and one or more fully connected layers 908.

Input processing module 550 uses short-term time window 601 to processes one or more features 602 and generates input feature sequence 608. In various embodiments, input processing module 550 concatenates numerical features 604 and categorical features 603 included in the one or more features 602 generating interaction features 609. Input processing module 550 then uses short-term time window 601 to process interaction features 609 and generate short-term interest features 610. Input processing module 550 processes one or more features 602 based on short-term time window 601 and generates input feature sequence 608.

User intent prediction model 560 processes input feature sequence 608 and generates user intent embeddings 704. Fully connected and normalization layers 901 process input feature sequence 608 and generate one or more processed input features. In various embodiments, fully connected and normalization layers 901 reduce the dimensionality of input feature sequence 608 and normalize input feature sequence 608 for consistent processing by intent encoding transformer 902. For example, fully connected and normalization layers 901 normalize input feature sequence 608 to ensure that the numerical values included in input feature sequence 608, such as timestamps or episode positions, are scaled to a consistent range (e.g., between 0 and 1).

Intent encoding transformer 902 processes processed input features and generates intent encoding 909. In some embodiments, intent encoding transformer 902 uses multi-head attention mechanisms to model both short-term and long-term dependencies in the processed input features. In various embodiments, intent encoding transformer 902 uses timestamp embeddings to preserve the temporal context of user interactions. Intent encoding transformer 902 generates intent encoding 909 Eₖ^{intent}, k=1, . . . , n, where each position k corresponds to the encoded context of the k-th user interaction included in the processed input features. In some embodiments, intent encoding transformer 902 includes a casual mask, which prevents processing future user interactions.

Intent encoding 909 is then processed by fully connected layers 903 to generate intent predictions 910 pₖ^{intent}^{ᵢ}, k=1, . . . , n. Intent predictions 910 pₖ^{intent}^{ᵢ} represents the predicted probabilities or scores for a specific intent label i, such as action type, genre preferences, content type, and/or the like. In some examples, fully connected layer 903 computes the prediction vector for the i-th intent at position k included in intent predictions 910 as:

$${p}_{k}^{{intent}_{i}} = σ ( {FC}_{i} ( {E}_{k}^{intent} ) ) ∈ {ℝ}^{{d}_{i}} , \qquad ( Equation 7 )$$

where FCᵢ denotes the fully connected transformation for the i-th intent, dᵢ is the number of unique labels for the i-th intent, and σ represents the Softmax function that converts raw scores into probabilities.

Attention layers 904 process intent predictions 910 and generate user intent embeddings 704. In various embodiments, attention layers 904 aggregates intent predictions 910 to generate user intent embeddings 704 Zₖ, k=1, . . . , n. In various embodiments, attention layers 904 projects each intent prediction vector pₖ^{intent}^{ᵢ} into a unified dimensional space via projection layers Projᵢ∈ [symbol] , and uses various attention mechanism to compute weights αᵢₙₜₑₙₜ_{ᵢ} for each intent. In some examples, the attention weights are calculated as:

$${α}_{{intent}_{i}} = {FC}_{att} ( {Proj}_{i} ( {p}_{k}^{{intent}_{i}} ) ) , \qquad ( Equation 8 )$$

where FCₐₜₜ∈ [symbol] is a fully connected attention layer. User intent embeddings 704 Zₖ, k=1, . . . , n can then be computed as:

$${Z}_{k} = {\sum }_{i = 1}^{M} σ ( {α}_{{intent}_{i}} ) \cdot ( {p}_{k}^{{intent}_{t}} ) , \qquad ( Equation 9 )$$

where M is the number of distinct intents being predicted, and σ normalizes the attention weights across all intents.

Content item prediction model 561 processes input feature sequence 608 and user intent embeddings 704 and generates recommendations 802. In various embodiments, concatenation layer 905 concatenates interaction features (e.g., categorical and numerical metadata of user interactions) included in input feature sequence 608 and short-term interest features included in user intent embeddings 704 and generates one or more concatenated features. Concatenated features form an intent-aware feature sequence {F₁ßS₁ßZ₁, . . . , FₙßSₙßZₙ}, where ß denotes the concatenation operator. Concatenated features include the user's historical interactions, short-term preferences, and predicted intents.

Fully connected and normalization layers 906 process concatenated features and generate one or more processed concatenated features. In various embodiments, fully connected and normalization layers 906 reduce the dimensionality of concatenated features and normalize concatenated features.

Item encoding transformer 907 processes the processed concatenated features and generates an item encoding 911. In various embodiments, item encoding transformer 907 models the relationships between the features at different sequence positions included in the processed concatenated features and use various multi-head attention mechanisms to capture both long-term user preferences and short-term session-level behaviors. For example, item encoding transformer 907 can prioritize recent user interactions within a session while also accounting for overarching user preferences derived from historical patterns. In some embodiments, for each position k in the feature sequence included in the processed concatenated features, item encoding transformer 907 generates an optimized feature representation (e.g., item encoding 911) Eₖ^{item}, k=1, . . . , n, which includes the context and relevance of the user interaction at that position.

Fully connected layers 908 process item encoding 911 and generate recommendations 802. In various embodiments, fully connected layers 908 include a scoring function which is used to compute the content item prediction score vector pₖ^{item}∈ [symbol] , k=1, . . . , n. In some examples, fully connected layers 908 compute the prediction scores as:

$${p}_{k}^{item} = σ ( {FC}_{item} ( {E}_{k}^{item} ) ) \qquad ( Equation 10 )$$

where FCᵢₜₑₘ is a scoring function, and σ is the softmax function that converts the raw scores into a probability distribution over the recommendation catalog. The probabilities in pₖ^{item} indicate the likelihood of the user engaging with each content item in the recommendation catalog as the next user interaction. In various embodiments, content item prediction model 561 ranks the content items based on probabilities pₖ^{item}, k=1, . . . , n to generate recommendations 802. For example, if a user has recently watched several action movies, content item prediction model 561 could assign high probabilities to similar action movies or related TV shows, reflecting the user's immediate preferences and intents.

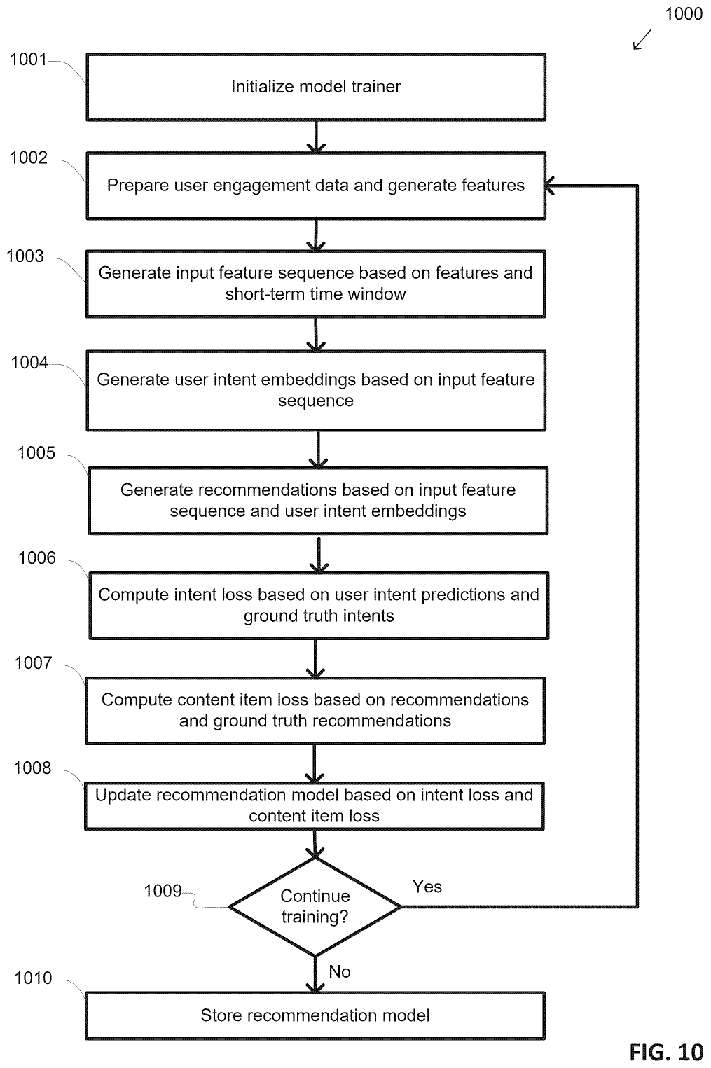

FIG. 10 sets forth a flow diagram of method steps for training the recommendation model 559, according to various embodiments. Although the method steps are described in conjunction with the systems of FIGS. 1-7 and 9, persons skilled in the art will understand that any system configured to perform the method steps in any order falls within the scope of the present disclosure.

As shown, a method 1000 begins with step 1001, where model trainer 515 is initialized. During initialization, model trainer 515 initializes various parameters to guide the training process. The initialized parameters include but are not limited to maximum sequence length n (e.g., 10), a learning rate η (e.g., 0.0005), which determines the step size in the training process, and the batch size [symbol] (e.g., 1024), which controls the number of user interaction sequences processed in mini-batches during training. Model trainer 515 also initializes the short-term time window 601 H, which defines the temporal range for generating short-term interest features from recent user interactions. In various embodiments, model trainer 515 initializes the dimensions of interaction features 609 (e.g., 523), short-term interest features 610 (e.g., 200), and user intent embeddings 704 (e.g., 200), respectively. In at least one embodiment, model trainer 515 initializes parameters specific to the transformer architecture included in intent encoding transformer 902 and item encoding transformer 907, including the number of attention heads (e.g., 8), the size of feed-forward layers, and the number of encoder layers (e.g., 2) to enable the modeling of sequential dependencies in user interactions. Additionally, model trainer 515 initializes duration weights dₖ to user interactions, emphasizing interactions with longer durations due to higher relevance, and initializes the balancing coefficient λ (e.g., 1) to weight the contributions of intent loss Lᵢₙₜₑₙₜ and content item loss Lᵢₜₑₘ during training as described by Equation 4. In some embodiments, model trainer 515 splits user engagement data 557 into training and test datasets.

At step 1002, data preparation module 516 prepares user engagement data 557 and generate features 602. In various embodiments, data preparation module 516 cleans the raw data included in user engagement data 557 to address missing values, inconsistencies, and irrelevant information. In some embodiments, Data preparation module 516 extracts numerical features 604, such as timestamps, content duration, and interaction counts, and normalizes numerical features 604 to maintain consistency across data points. Data preparation module 516 also extracts categorical features 603, such as action types, genre preferences, content types, and time-since-release labels. In at least one embodiment, data preparation module 516 organizes user engagement data 557 into short-term and long-term sequences.

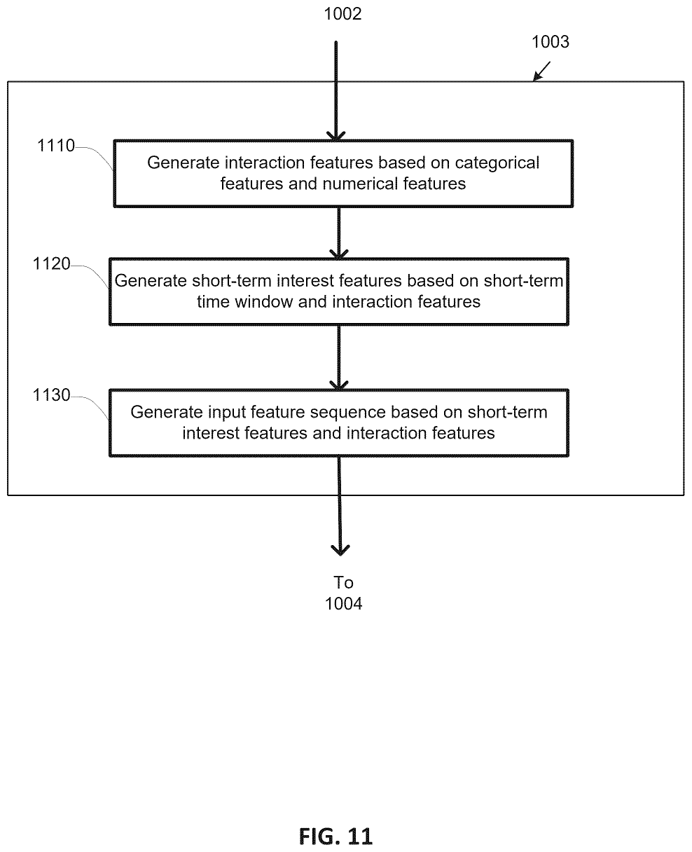

At step 1003, input processing module 550 generates input feature sequence 608 based on features 602 and short-term time window 601. In various embodiments, concatenation module 605 concatenates numerical features 604 and categorical features 603 included in features 602 and generates interaction features 609. Input processing module 550 uses short-term encoding module 606 to process interaction features 609 and short-term time window 601 and generate short-term interest features 610. In some embodiments, input processing module 550 uses concatenation module 607 to concatenate short-term interest features 610 and interaction features 609 and generate input feature sequence 608. Step 1003 is described in more detail in conjunction with FIG. 11.

At step 1004, user intent prediction model 560 generates user intent embeddings 803 based on input feature sequence 608. In various embodiments, user intent prediction model 560 analyzes temporal dependencies by leveraging timestamp and ordering information to understand how user behavior evolves over time. In some examples, such as the example described in conjunction with FIG. 9, user intent prediction model 560 includes intent encoding transformer 902, which models long-term user interests using multi-head attention mechanisms and timestamp-based positional encoding. Intent encoding transformer 902 also includes a causal mask to ensure that only past user interactions are considered during intent prediction. In various embodiments, user intent prediction model 560 generates user intent embeddings 704, which include a probability distribution over possible intent labels.

At step 1005, content item prediction model 561 generates recommendations 708 based on input feature sequence 608 and user intent embeddings 704. In various embodiments, content item prediction model 561 concatenates input feature sequence 608 with user intent embeddings 704 to form an intent-aware feature sequence. In some examples, such as the example described in conjunction with FIG. 9, content item prediction model 561 includes item encoding transformer 907 that processes the intent-aware feature sequence. Item encoding transformer 907 uses multi-head attention mechanisms to model relationships and dependencies across the sequence and generates optimized representations for each position. In various embodiments, content item prediction model 561 generates recommendations 708 as a ranked list of content items, where each item is assigned a score indicating the likelihood of user engagement.

At step 1006, intent loss calculation module 518 computes intent loss 703 based on user intent predictions 706 and ground truth intents 702. In some examples, intent loss calculation module 518 computes intent loss 703 as described in Equation 3. In some embodiments, when the intent prediction has multiple ground-truth labels, intent loss calculation module 518 uses binary cross-entropy, with all the ground-truth labels having positive labels and no ground truths having negative labels.

At step 1007, content item loss calculation module 519 computes content item loss 705 based on recommendations 708 and ground truth recommendations 701. In some embodiments, for each position in a user profile, content item prediction model 561 predicts the next content item. In at least one embodiment, content item loss calculation module 519 uses different weights proportional to the duration of various content items, which assigns higher weights to user interactions with longer durations. In some examples, content item loss calculation module 519 uses a weighted-Cross-Entropy loss for next content item prediction as described in Equation 3.

At step 1008, model trainer 515 updates recommendation model 559 based on intent loss 703 and content item loss 705. In some embodiments, model trainer 515 calculates the total loss based on intent loss 703 and content item loss 705, such as using Equation 4. In at least one embodiment, model trainer 515 uses a fixed or trainable hyperparameter to balances the influence of intent prediction and content item prediction when calculating total loss. In some embodiments, model trainer 515 updates the parameters of recommendation model 559 based on total loss using an optimization algorithm, such as Adam.

At step 1009, model trainer 515 checks whether to continue training recommendation model 559. In various embodiments, model trainer 515 trains recommendation model 559 iteratively until a stopping criterion is met, such as reaching a maximum number of iterations, a plateauing loss function, and/or the like. In various embodiments, model trainer 515 uses various standard ranking metrics typically used in recommendation systems for evaluation. In some examples, model trainer 515 uses the MRR metric as described in Equation 5 and/or the WMRR metric as described in Equation 6 to evaluate how accurately recommendation model 559 predicts the next content item. If a stopping criterion is met, method 1000 proceeds to step 1010. If a stopping criterion is not met, method 1000 proceeds to step 1002.

At step 1010, model trainer 515 stores recommendation model 559. In various embodiments, model trainer 515 stores recommendation model 559 in data store 520, or elsewhere

FIG. 11 sets forth a flow diagram of method steps for generating an input feature sequence 608, according to various embodiments. Although the method steps are described in conjunction with the systems of FIGS. 1-6 and 11, persons skilled in the art will understand that any system configured to perform the method steps in any order falls within the scope of the present disclosure.

As shown, step 1003 of the method 1000, begins with step 1110 wherein concatenation module 605 generates interaction features 609 based on categorical features 603 and numerical features 604. In various embodiments, concatenation module 605 converts categorical features 603 of a user interaction into embeddings using trainable embedding layers, where each categorical feature 603 is mapped to a specific embedding vector. In at least one embodiment, concatenation module 605 normalizes numerical features 604 (e.g., scaled between 0 and 1) and treats numerical features 604 as 1-dimensional features. In some examples, concatenation module 605 generates interaction feature 609 by concatenating the embeddings of the categorical features 603 with the normalized numerical features 604 as described in Equation 1.

At step 1120, short-term encoding module 606 generates short-term interest features 610 based on short-term time window 601 and interaction features 609. In various embodiments short-term encoding module 606 identifies recent user interactions within short-term time window 601 and aggregates the corresponding interaction features 609. In some embodiments, short-term encoding module 606 uses a personalized timestamp-based approach, extracting the most relevant signals from the user's recent interactions and capturing session-specific interests to generate short-term interest features 610. In some examples, short-term encoding module 606 uses an encoder to generate short-term interest features 610 as described by Equation 2.

At step 1130, concatenation module 607 generates input feature sequence 608 based on short-term interest features 610 and interaction features 609. In various embodiments, concatenation module 607 concatenates short-term interest features 610 and interaction features 609 and generates input feature sequence 608.

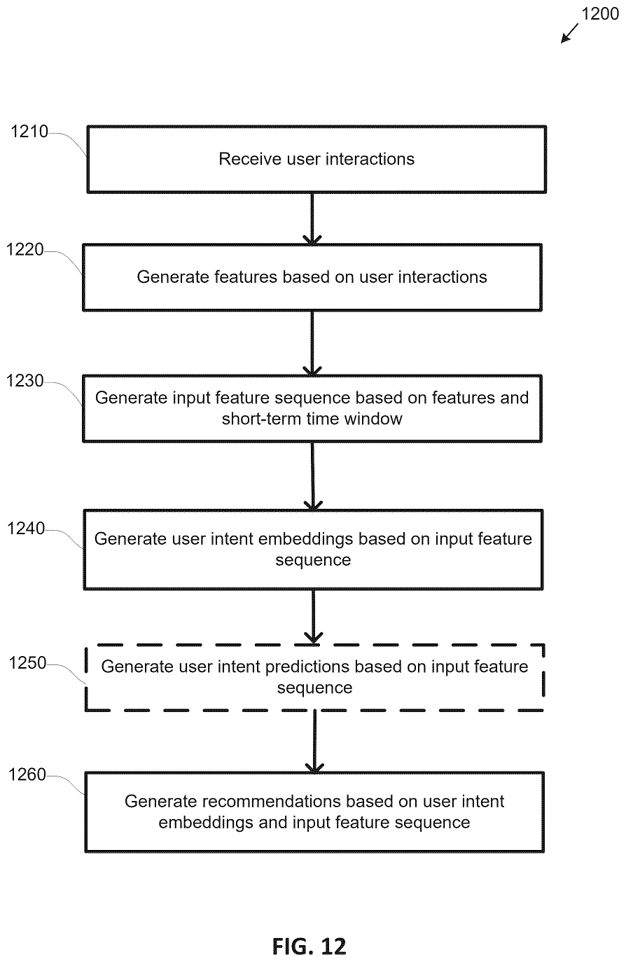

FIG. 12 sets forth a flow diagram of method steps for generating recommendations 802, according to various embodiments. Although the method steps are described in conjunction with the systems of FIGS. 1-9, persons skilled in the art will understand that any system configured to perform the method steps in any order falls within the scope of the present disclosure.

A method 1200 begins with step 1210 where recommendation application 546 receives user interactions 801. In various embodiments, recommendation application 546 receives user interactions 801 through various I/O devices (not shown), including direct interactions, browsing activity, and implicit feedback, such as engagement duration, skipped items, and/or the like.

At step 1220, feature extraction module 547 generates features based on user interactions 801. In various embodiments, feature extraction module 547 maps each user interaction 801 to various metadata attributes and extracts one or more features 602, which include categorical features 603 and numerical features 604.

At step 1230, input processing module 550 generates input feature sequence 608 based on features 602 and short-term time window 601. In various embodiments, input processing module 550 included in the trained recommendation model 559 uses short-term time window 601 to process one or more features and generate input feature sequence 608.

At step 1240, the trained user intent prediction model 560 generates user intent embeddings 803 based on input feature sequence 608. In various embodiments, the trained user intent prediction model 560 analyzes temporal dependencies by leveraging timestamp and ordering information to understand how user behavior evolves over time. In some examples, such as the example described in conjunction with FIG. 9, the trained user intent prediction model 560 includes intent encoding transformer 902, which models long-term user interests using multi-head attention mechanisms and timestamp-based positional encoding. The trained intent encoding transformer 902 also applies a causal mask to ensure that only past user interactions are considered during intent prediction. In various embodiments, the trained user intent prediction model 560 generates user intent embeddings 704, which include a probability distribution over possible intent labels.

At optional step 1260, the trained user intent prediction model 560 generates user intent predictions 804 based on input feature sequence 608. In various embodiments, user intent predictions 804 are used in downstream recommendations tasks, such as improving recommendation accuracy, refining search results, enhancing user engagement, and/or the like.

At step 1260, the trained content item prediction model 561 generates recommendations 802 based on user intent embeddings 803 and input feature sequence 608. In various embodiments, content item prediction model 561 concatenates input feature sequence 608 with user intent embeddings 704 to form an intent-aware feature sequence. In some examples, such as the example described in conjunction with FIG. 9, content item prediction model 561 includes item encoding transformer 907 that processes the intent-aware feature sequence. Item encoding transformer 907 uses multi-head attention mechanisms to model relationships and dependencies across the sequence and generates optimized representations for each position. In various embodiments, content item prediction model 561 generates recommendations 708 as a ranked list of content items, where each item is assigned a score indicating the likelihood of user engagement.

In sum, techniques are disclosed to generate personalized recommendations using hierarchical MTL. The disclosed techniques include a recommendation model, which is a machine learning model that processes one or more features and generates recommendations. The recommendation model includes an input processing module that processes one or more features and generates an input feature sequence, a user intent prediction model that processes the input feature sequence and generates user intent embeddings, and a content item prediction model which processes the input feature sequence and user intent embeddings and generates recommendations. In various embodiments, input processing module uses a short-term time window to generate short-term interest features which are concatenated with interaction features derived from the one or more features. To train the recommendation model, input processing module generates the input feature sequence based on the one or more features generated from user interaction data. The input feature sequence and ground truth data included in user engagement data are used to calculate loss functions for user intent prediction model and content item prediction model. The loss functions are used to update the recommendation model. Once the recommendation model is trained, the trained recommendation model can be used to generate personalized recommendations based on user interactions.

At least one technical advantage of the disclosed techniques relative to prior art is that the disclosed techniques integrate user intent predictions into the content item prediction process, creating a hierarchical recommendation model. By leveraging inferred user intent embeddings as an input for content item prediction, the disclosed techniques enable more accurate and personalized recommendations aligned with the user's current context. Another advantage of the disclosed techniques is the ability to distinguish between short-term session-specific interests and long-term habitual user preferences, which allows the recommendation model to adapt dynamically to shifts in user behavior over short time windows without losing sight of broader user interaction patterns. These technical advantages represent one or more technological improvements over prior art approaches.

1. In some embodiments, a computer-implemented method for generating recommendations comprises generating, based on one or more features and a short-term time window, an input feature sequence, generating, based on the input feature sequence, one or more user intent embeddings using a first machine learning model, and generating, based on the input feature sequence and the one or more user intent embeddings, one or more recommendations using a second machine learning model.

2. The computer implemented of clause 1, wherein the one or more features comprises one or more categorical features and one or more numerical features.

3. The computer-implemented method of clauses 1 or 2, wherein generating the input feature sequence comprises generating, based on the one or more numerical features and the one or more numerical features, one or more interaction features, generating, based on the one or more interaction features and the short-term time window, one or more short-term interest features, and generating, based on the one or more short-term interest features and the one or more interaction features, the input feature sequence.

4. The computer-implemented method of any of clauses 1-3, wherein generating the one or more short-term interest features comprises processing the input feature sequence using an encoder and timestamp-based positional encoding.

5. The computer-implemented method of any of clauses 1-4, wherein generating the input feature sequence comprises concatenating the one or more short-term interest features and the one or more interaction features.

6. The computer implemented method of any of clauses 1-5, wherein generating the one or more user intent embeddings using the first machine learning model comprises generating, based on the input feature sequence, one or more processed input features using one or more fully connected and normalization layers, generating, based on the one or more processed input features, an intent encoding using an intent encoding transformer, generating, based on the intent encoding, one or more intent predictions using one or more fully connected layers, and generating, based on intent predictions, the one or more user intent embeddings using one or more attention layers.

7. The computer-implemented method of any of clauses 1-6, wherein generating the intent encoding comprises using a causal mask.

8. The computer-implemented method of any of clauses 1-7, wherein generating the one or more user intent embeddings comprises aggregating the one or more intent predictions.

9. The computer implemented method of any of clauses 1-8, wherein generating the one or more recommendations using the second machine learning model comprises generating, based on the one or more user intent embeddings, one or more concatenated features using one or more concatenation layers, generating, based on the one or more concatenated features, one or more processed concatenated features using one or more fully connected and normalization layers, generating, based on the one or more processed concatenated features, an item encoding using an item encoding transformer, and generating, based on the item encoding, the one or more recommendations using one or more fully connected layers.

10. The computer-implemented method of any of clauses 1-9, wherein the first machine learning model is trained based on an intent loss computed using the one or more user intent embeddings and one or more ground truth intents, and the second machine learning model is trained based on a content item loss computed using the one or more recommendations and one or more ground truth recommendations.

11. The computer-implemented method of any of clauses 1-10, wherein the intent loss is a binary cross-entropy loss, and the content item loss is a weighted cross-entropy loss function.

12. In some embodiments, one or more non-transitory computer-readable media store instructions that, when executed by one or more processors, cause the one or more processors to perform a method for generating recommendations, the method comprising generating, based on one or more features and a short-term time window, an input feature sequence, generating, based on the input feature sequence, one or more user intent embeddings using a first machine learning model, and generating, based on the input feature sequence and the one or more user intent embeddings, one or more recommendations using a second machine learning model.

13. The one or more non-transitory computer-readable media of clause 12, wherein the one or more features comprises one or more categorical features and one or more numerical features.

14. The one or more non-transitory computer-readable media of clauses 12 or 13, wherein generating the input feature sequence comprises generating, based on the one or more numerical features and the one or more numerical features, one or more interaction features, generating, based on the one or more interaction features and the short-term time window, one or more short-term interest features, and generating, based on the one or more short-term interest features and the one or more interaction features, the input feature sequence.

15. The one or more non-transitory computer-readable media of any of clauses 12-14, wherein generating the one or more short-term interest features comprises processing the input feature sequence using an encoder and timestamp-based positional encoding.

16. The one or more non-transitory computer-readable media of any of clauses 12-15, wherein generating the input feature sequence comprises concatenating the one or more short-term interest features and the one or more interaction features.

17. The one or more non-transitory computer-readable media of any of clauses 12-16, wherein generating the one or more user intent embeddings using the first machine learning model comprises generating, based on the input feature sequence, one or more processed input features using one or more fully connected and normalization layers, generating, based on the one or more processed input features, an intent encoding using an intent encoding transformer, generating, based on the intent encoding, one or more intent predictions using one or more fully connected layers, and generating, based on intent predictions, the one or more user intent embeddings using one or more attention layers.

18. The one or more non-transitory computer-readable media of any of clauses 12-17, wherein generating the one or more user intent embeddings comprises aggregating the one or more intent predictions.

19. The one or more non-transitory computer-readable media of any of clauses 12-18, wherein generating the one or more recommendations using the second machine learning model comprises generating, based on the one or more user intent embeddings, one or more concatenated features using one or more concatenation layers, generating, based on the one or more concatenated features, one or more processed concatenated features using one or more fully connected and normalization layers, generating, based on the one or more processed concatenated features, an item encoding using an item encoding transformer, and generating, based on the item encoding, the one or more recommendations using one or more fully connected layers.

20. In some embodiments, a system comprises one or more memories storing instructions, and one or more processors that are coupled to the one or more memories and, when executing the instructions, are configured to generating, based on one or more features and a short term time window, an input feature sequence, generating, based on the input feature sequence, one or more user intent embeddings using a first machine learning model, and generating, based on the input feature sequence and the one or more user intent embeddings, one or more recommendations using a second machine learning model.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating recommendations, the method comprising:
generating, based on one or more features and a short-term time window, an input feature sequence;
generating, based on the input feature sequence, one or more user intent embeddings using a first machine learning model; and
generating, based on the input feature sequence and the one or more user intent embeddings, one or more recommendations using a second machine learning model.

2. The computer implemented of claim 1, wherein the one or more features comprises one or more categorical features and one or more numerical features.

3. The computer-implemented method of claim 2, wherein generating the input feature sequence comprises:
generating, based on the one or more numerical features and the one or more numerical features, one or more interaction features;
generating, based on the one or more interaction features and the short-term time window, one or more short-term interest features; and
generating, based on the one or more short-term interest features and the one or more interaction features, the input feature sequence.

4. The computer-implemented method of claim 3, wherein generating the one or more short-term interest features comprises processing the input feature sequence using an encoder and timestamp-based positional encoding.

5. The computer-implemented method of claim 3, wherein generating the input feature sequence comprises concatenating the one or more short-term interest features and the one or more interaction features.

6. The computer implemented method of claim 1, wherein generating the one or more user intent embeddings using the first machine learning model comprises:
generating, based on the input feature sequence, one or more processed input features using one or more fully connected and normalization layers;
generating, based on the one or more processed input features, an intent encoding using an intent encoding transformer;
generating, based on the intent encoding, one or more intent predictions using one or more fully connected layers; and
generating, based on intent predictions, the one or more user intent embeddings using one or more attention layers.

7. The computer-implemented method of claim 6, wherein generating the intent encoding comprises using a causal mask.

8. The computer-implemented method of claim 6, wherein generating the one or more user intent embeddings comprises aggregating the one or more intent predictions.

9. The computer implemented method of claim 1, wherein generating the one or more recommendations using the second machine learning model comprises:
generating, based on the one or more user intent embeddings, one or more concatenated features using one or more concatenation layers;
generating, based on the one or more concatenated features, one or more processed concatenated features using one or more fully connected and normalization layers;
generating, based on the one or more processed concatenated features, an item encoding using an item encoding transformer; and
generating, based on the item encoding, the one or more recommendations using one or more fully connected layers.

10. The computer-implemented method of claim 1, wherein:
the first machine learning model is trained based on an intent loss computed using the one or more user intent embeddings and one or more ground truth intents; and
the second machine learning model is trained based on a content item loss computed using the one or more recommendations and one or more ground truth recommendations.

11. The computer-implemented method of claim 10, wherein:
the intent loss is a binary cross-entropy loss; and
the content item loss is a weighted cross-entropy loss function.

12. One or more non-transitory computer-readable media storing instructions that, when executed by one or more processors, cause the one or more processors to perform a method for generating recommendations, the method comprising:
generating, based on one or more features and a short-term time window, an input feature sequence;
generating, based on the input feature sequence, one or more user intent embeddings using a first machine learning model; and
generating, based on the input feature sequence and the one or more user intent embeddings, one or more recommendations using a second machine learning model.

13. The one or more non-transitory computer-readable media of claim 12, wherein the one or more features comprises one or more categorical features and one or more numerical features.

14. The one or more non-transitory computer-readable media of claim 13, wherein generating the input feature sequence comprises:
generating, based on the one or more numerical features and the one or more numerical features, one or more interaction features;
generating, based on the one or more interaction features and the short-term time window, one or more short-term interest features; and
generating, based on the one or more short-term interest features and the one or more interaction features, the input feature sequence.

15. The one or more non-transitory computer-readable media of claim 14, wherein generating the one or more short-term interest features comprises processing the input feature sequence using an encoder and timestamp-based positional encoding.

16. The one or more non-transitory computer-readable media of claim 14, wherein generating the input feature sequence comprises concatenating the one or more short-term interest features and the one or more interaction features.

17. The one or more non-transitory computer-readable media of claim 13, wherein generating the one or more user intent embeddings using the first machine learning model comprises:
generating, based on the input feature sequence, one or more processed input features using one or more fully connected and normalization layers;
generating, based on the one or more processed input features, an intent encoding using an intent encoding transformer;
generating, based on the intent encoding, one or more intent predictions using one or more fully connected layers; and
generating, based on intent predictions, the one or more user intent embeddings using one or more attention layers.

18. The one or more non-transitory computer-readable media of claim 17, wherein generating the one or more user intent embeddings comprises aggregating the one or more intent predictions.

19. The one or more non-transitory computer-readable media of claim 12, wherein generating the one or more recommendations using the second machine learning model comprises:
generating, based on the one or more user intent embeddings, one or more concatenated features using one or more concatenation layers;
generating, based on the one or more concatenated features, one or more processed concatenated features using one or more fully connected and normalization layers;
generating, based on the one or more processed concatenated features, an item encoding using an item encoding transformer; and
generating, based on the item encoding, the one or more recommendations using one or more fully connected layers.

20. A system, comprising:
one or more memories storing instructions; and
one or more processors that are coupled to the one or more memories and, when executing the instructions, are configured to:
generating, based on one or more features and a short term time window, an input feature sequence;
generating, based on the input feature sequence, one or more user intent embeddings using a first machine learning model; and
generating, based on the input feature sequence and the one or more user intent embeddings, one or more recommendations using a second machine learning model.
